(19) United States
(12) Patent Application Publication
(10) Pub. No.: US 2017/0059332 A1
(43) Pub. Date: Mar. 2, 2017

(54) SYSTEM AND METHOD FOR DETERMINING DTE OF ENVIRONMENTALLY-FRIENDLY VEHICLE

(71) Applicant: HYUNDAI MOTOR COMPANY, Seoul (KR)

(72) Inventor: Kwon Hyoung CHOI, Suwon-si (KR)

(21) Appl. No.: 14/957,579

(22) Filed: Dec. 2, 2015

(30) Foreign Application Priority Data
Aug. 26, 2015 (KR) 10-2015-0120270

(51) Int. Cl. G01C 21/20; G07C 5/08; B60L 11/18

(52) U.S. Cl. CPC G01C 21/20; B60L 11/1861; G07C 5/08; B60L 2250/16

(57) ABSTRACT

A system and method for determining a distance to empty (DTE) of an environmentally-friendly vehicle, which enable a driver to recognize that a DTE is gradually and linearly decreased as an actual travelling distance is increased. This provides capability of more conveniently and intuitively guiding a DTE to a driver by calculating an ideal and final DTE desired by the driver by using an actual travelling distance measured by an odometer (ODO) and displaying the calculated final DTE on a cluster.

### CROSS-REFERENCE TO RELATED APPLICATION

This application claims under 35 U.S.C. §119(a) the benefit of Korean Patent Application No. 10-2015-0120270 filed on Aug. 26, 2015, the entire contents of which are incorporated herein by reference.

### BACKGROUND

(a) Technical Field

The present disclosure relates to a system and a method for determining a distance to empty (DTE) of an environmentally-friendly vehicle. More particularly, it relates to a system and a method for determining a DTE of an environmentally-friendly vehicle, which enable a driver to recognize that a DTE is gradually and linearly decreased as an actual travelling distance is increased.

(b) Background Art

Similar to what is provided in an internal combustion engine vehicle, which predicts a distance to empty (DTE) based on a current gasoline fuel level and notifies a driver of the predicted DTE, an environmentally-friendly vehicle, such as an electric vehicle and a hybrid vehicle provides a function of estimating a DTE based on a current remaining capacity of a battery and displaying the estimated DTE on a cluster and the like.

Particularly, a one-charging travelling distance of an electric vehicle is limited within a maximum of 200 km, so that a DTE is provided to the driver as very important operation information.

A method of determining a DTE of an electric vehicle according to related art includes a method of calculating a DTE by using a relationship between a state of charge (SOC)%, which is the remaining energy of a high voltage battery, and an energy consumption rate per distance of the vehicle.

That is, an existing DTE (km) is calculated by multiplying fuel efficiency (km/kWh) obtained by blending past average travelling fuel efficiency (fuel efficiency of the electric vehicle) and current travelling fuel efficiency by available battery energy (kWh) as represented in Equation 1) below.

DTE(km)=fuel efficiency [km/kWh]×available battery energy [kWh] Equation 1)

In this case, the available battery energy is a value predictable based on the SOC of the battery and is comparatively accurate and linear, but is increased by regenerative energy when the electric vehicle travels a long downhill road, that is, as the electric vehicle descends a long slope, so that the available battery energy may not be decreased.

As can be seen in FIG. 1, it is difficult to accurately predict fuel efficiency (km/kWh) of the electric vehicle through a DTE curve predicted by the existing method, so that the DTE curve is not linear compared to an ideal DTE curve, thereby causing the problems described below.

First, the quantity of battery energy consumption is different according to a city road, a country road, and an expressway, and particularly, the prediction of fuel efficiency is not accurate, so that a DTE is underpredicted or overpredicted.

Second, since it is difficult to derive battery energy consumed when an air conditioning device is operated as reduced fuel efficiency, accuracy of a DTE deteriorates.

Third, when the electric vehicle descends a long downhill road, available battery energy may be increased by battery charging according to regenerative braking of a motor. Hence, there is a problem in that a DTE reversal phenomenon, in which a DTE is predicted as 200 km during initial travelling, but the DTE is rather increased to 210 km after the electric vehicle descends a long downhill road of 10 km, arises.

Fourth, a controller predicting a DTE is sensitive to disturbance, so that there is a problem in that a chattering phenomenon, in which a DTE is momentarily increased or decreased, is produced.

As described above, when a DTE is predicted while the electric vehicle initially travels, and then the DTE is repeatedly increased or decreased as a travelling distance is increased, a driver, who visually checks the DTE through the cluster, may be rather confused, and recognize that accuracy of the DTE deteriorates.

By contrast, the driver may recognize a gradual and linear decrease of a DTE as travelling distance is increased after the DTE is predicted during initial travelling as an ideal DTE.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with the prior art.

Described are a system and a method for calculating a distance to empty (DTE) of an environmentally-friendly vehicle, which are capable of more conveniently and intuitively providing a DTE to a driver by determining an ideal and final DTE desired by the driver by using an actual travelling distance measured by an odometer (ODO) and displaying the calculated final DTE on a cluster.

In one aspect, a system for determining a distance to empty (DTE) of an environmentally-friendly vehicle, includes: an initial calculating unit configured to calculate a first predicted DTE (DTE_{predict}) at an initial DTE prediction time using distance to empty (DTE) prediction logic (DTE(km)=fuel efficiency [km/kWh]×available battery energy [kWh]); a predicted DTE recalculation determining unit configured to calculate an actual travelling distance (d) travelling from a just previous time, at which the predicted DTE (DTE_{predict}) is calculated, compare the calculated actual travelling distance (d) with a predetermined actual travelling distance (D), and determine whether to recalculate the predicted DTE; and a displayed DTE calculating unit configured to calculate a displayed DTE (DTE_{final}(t)) as a linearly decreasing value when the actual travelling distance (d) travelling from the just previous time, at which the predicted DTE (DTE_{predict}) is calculated, to a specific time is smaller than the predetermined actual travelling distance (D).

In another aspect, the present invention provides a method for calculating a distance to empty (DTE) of an environmentally-friendly vehicle, including: calculating a first predicted DTE (DTE_{predict}) at an initial DTE prediction time using distance to empty (DTE) prediction logic (DTE(km)=fuel efficiency [km/kWh]×available battery energy [kWh]); calculating an actual travelling distance (d) travelling from a just previous time, at which the predicted DTE (DTE_{predict}) is calculated, comparing the calculated actual travelling distance (d) with a predetermined actual travelling distance (D), and determining whether to recalculate the predicted DTE; and calculating a displayed DTE (DTE_{final}(t)) as a linearly decreasing value when the actual travelling distance (d) travelling from the just previous time, at which the predicted DTE (DTE_{predict}) is calculated, to a specific time is smaller than the predetermined actual travelling distance (D) and displaying the calculated DTE on a cluster.

Through the aforementioned technical solutions, the present invention provides the effects below.

According to embodiments of the present invention, it is possible to enable a driver to recognize that a DTE is gradually and linearly decreased as a travelling distance is increased, thereby more stably and intuitively guiding the DTE to the driver.

Other aspects and preferred embodiments of the invention are discussed below.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a graph illustrating a comparison of an ideal DTE prediction curve for a driver with an existing DTE prediction curve;

FIG. 2 is a graph illustrating a comparison of a DTE prediction curve according to an embodiment of the present invention and an ideal DTE prediction curve;

FIG. 3 is a flowchart illustrating a method of calculating a DTE of an environmentally-friendly vehicle according to an embodiment of the present invention; and

FIG. 4 is a graph illustrating a comparison of a DTE prediction curve according to an embodiment of the present invention, an existing DTE prediction curve, and a curve obtained by subtracting an actual travelling distance from an existing DTE prediction value.

FIG. 5 is a block diagram illustrating a hardware configuration for calculating distance to empty (DTE) of an environmentally-friendly vehicle according to an embodiment of the present invention

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, an exemplary embodiment of the present invention will be described in detail with reference to the accompanying drawings.

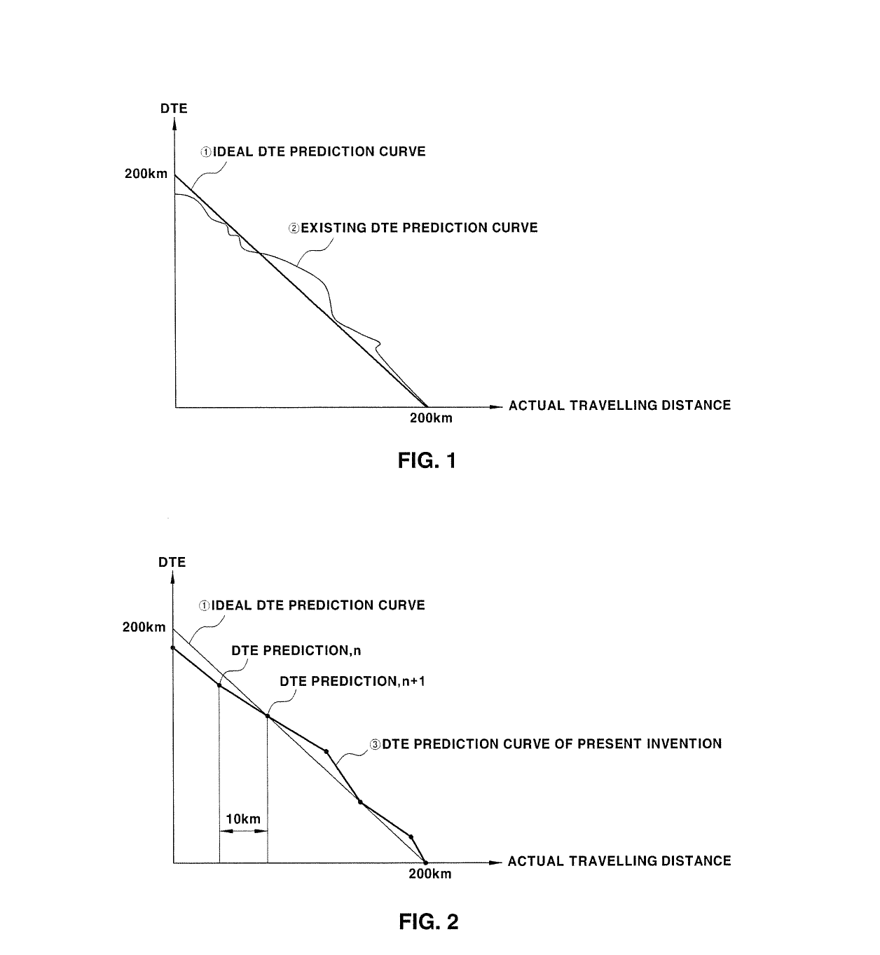

Referring to FIG. 1, an ideal distance to empty (DTE) prediction curve of an environmentally-friendly vehicle is curve \textcircled{1}, and an existing DTE prediction curve is curve \textcircled{2}.

The ideal DTE prediction curve represents that a DTE is linearly decreased by a travelling distance from a predicted DTE (for example, 200 km) during initial travelling, and when the DTE reaches the predicted DTE, the environmentally-friendly vehicle stops.

The current DTE prediction curve represents that the DTE is momentarily increased or decreased according to a city road/country road/expressway, an operation of an air conditioning device, travelling a long downhill road, and any influence of disturbances.

Accordingly, fuel efficiency (km/kWh) of the electric vehicle is not linear compared to the ideal DTE, so that it is impossible to accurately predict fuel efficiency, and when the DTE is repeatedly increased or decreased as the travelling distance is increased, a driver may recognize that accuracy of the DTE rather deteriorates.

By contrast, the driver may recognize a gradual and linear decrease of a DTE as a travelling distance is increased after the DTE is predicted during initial travelling as an ideal DTE, and thus has reliability for accuracy of the DTE.

Accordingly, the present invention puts emphasis on more conveniently and intuitively informing a DTE to a driver by calculating an ideal DTE desired by the driver by using an actual travelling distance measured by an odometer (ODO) and displaying the calculated DTE on a cluster.

Referring to FIG. 2, an ideal DTE prediction curve of the environmentally-friendly vehicle is curve \textcircled{1}, and a curve indicated with \textcircled{3} represents a DTE prediction curve of the present invention using an actual travelling distance.

A concept of the method of predicting the DTE according to an embodiment of the present invention is that, as illustrated in FIG. 2, predicting a first DTE (DTE prediction, n), calculating a first final DTE by subtracting a first actual travelling distance (for example, 1 to 9 km) from the predicted first DTE, predicting a second DTE (DTE prediction, n+1) after travelling a predetermined distance (for example, 10 km), and calculating a second final DTE obtained by subtracting a second actual travelling distance from the second DTE again, which are are repeatedly performed.

A system and a method for predicting a DTE of an environmentally-friendly vehicle according to an exemplary embodiment of the present invention will be described in more detail below.

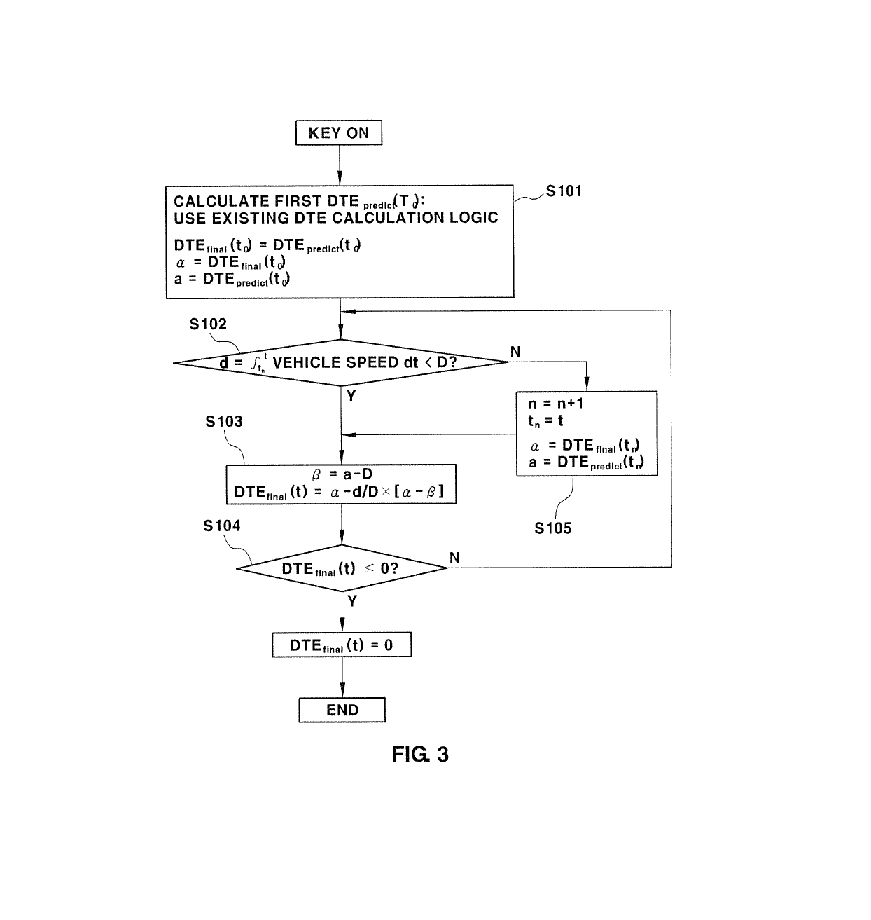

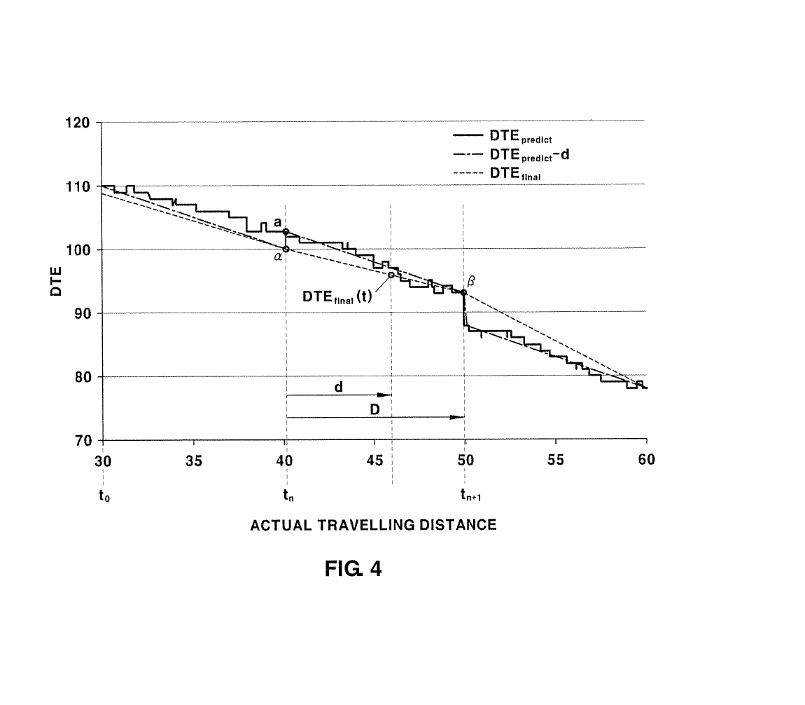

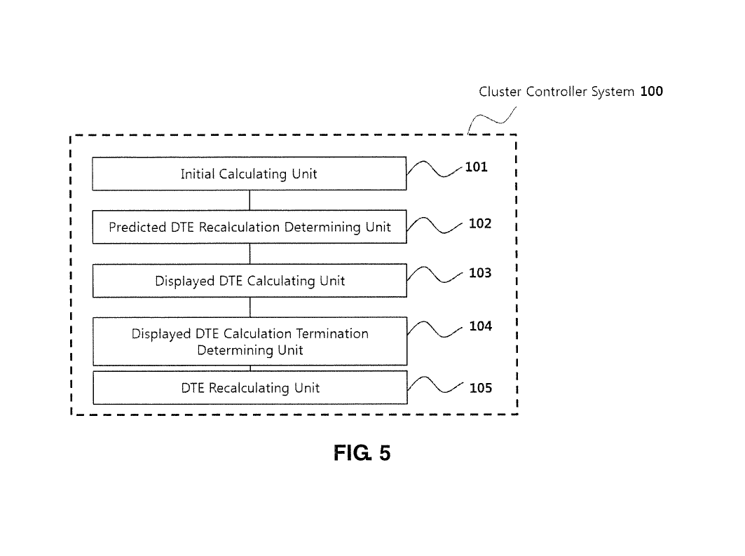

FIG. 3 is a flowchart illustrating a method of determining a DTE of an environmentally-friendly vehicle according to an embodiment of the present invention, FIG. 4 is a graph showing a comparison of a DTE prediction curve according to an embodiment the present invention, an existing DTE prediction curve, and a curve obtained by subtracting an actual travelling distance from an existing DTE prediction value, and FIG. 5 is a block diagram for calculating distance to empty (DTE) of an environmentally-friendly vehicle according to an embodiment of the present invention.

In FIG. 4, a solid line represents an existing DTE prediction value, an alternated long and short dash line represents a value obtained by subtracting an actual travelling distance d from the existing DTE prediction value, and a dotted line represents a final DTE actually provided to a driver.

As illustrated in FIG. 5, the method of determining the DTE of the environmentally-friendly vehicle according to an embodiment of the present invention is performed by a cluster controller system 100 including an initial calculating unit 101, a predicted DTE recalculation determining unit 102, a displayed DTE calculating unit 103, a displayed DTE calculation termination determining unit 104, a DTE recalculating unit 105, and the like.

First, the initial calculating unit calculates a first predicted DTE (a=DTE_{predict}(t₀)) at an initial DTE prediction time t₀ (S101).

The predicted DTE may be predicted by existing DTE prediction logic (for example, DTE (km)=fuel efficiency (km/kWh)×available battery energy (kWh)), a similar prediction logic, and the like, and as described above, has a non-linear characteristic when a travelling distance is increased.

In this case, in the initial calculating unit 101 of the cluster controller system 100 mounted in the vehicle, the first predicted DTE (a=DTE_{predict}(t₀)) calculated by using the existing DTE prediction logic (for example, DTE (km)=fuel efficiency (km/kWh)×available battery energy (kWh)) and a displayed DTE (α=DTE_{final}(t₀)) at the initial DTE prediction time t₀ to be actually displayed to a driver through the cluster by using an actual travelling distance have the same value because an actual travelling distance does not exist at the initial DTE prediction time t₀.

Accordingly, the first predicted DTE (a=DTE_{predict}(t₀)) at the initial DTE prediction time t₀ predicted by the initial calculating unit is first displayed on the cluster through digitization and the like, so that the driver first recognizes the first predicted DTE (a=DTE_{predict}(t₀)) calculated at the initial DTE prediction time t₀ displayed on the cluster as a current DTE.

Next, after the vehicle travels a predetermined distance, the predicted DTE recalculation determining unit determines whether to recalculate the predicted DTEDTE_{predict}.

That is, the predicted DTE recalculation determining unit calculates an actual travelling distance d travelling from a just previous time t₀ or tₙ, at which the predicted DTE DTE_{predict} is calculated, compares the calculated actual travelling distance d with a predetermined actual travelling distance D, and determines whether to recalculate the predicted DTE DTE_{predict} (S102).

In this case, the actual travelling distance d uses an actual travelling distance measured by the ODO, and the predetermined actual travelling distance D means an actual travelling distance set for determining a time, at which the predicted DTE DTE_{predict} is recalculated.

Next, when the actual travelling distance d travelling from the immediately previous time t₀ or tₙ, at which the predicted DTE is calculated by using the existing DTE prediction logic, is smaller than the predetermined actual travelling distance D, the displayed DTE calculating unit calculates a displayed DTE DTE_{final}(t) actually displayed on the cluster as a linearly decreasing value (S103).

Referring to FIG. 4, when it is assumed that the displayed DTE value displayed on the cluster at the time tₙ is α and the predicted DTE calculated by using the existing DTE prediction logic at the time tₙ is a, α is different from a, so that α and a cannot be directly converted. Accordingly, when a DTE on a straight line connecting α and β for a time from tₙ to tₙ₊₁ is calculated through Equation 2 below and displayed on the cluster, it is possible to transmit a change of the linearly decreasing DTE to the driver.

More particularly, when the actual travelling distance d travelling from the immediately previous time tₙ, at which the predicted DTE is calculated by using the existing DTE prediction logic, to a specific time is smaller than the predetermined actual travelling distance D, the displayed DTE calculating unit calculates a displayed DTE DTE_{final}(t) at the specific time by using Equation 2 below.

Displayed DTE DTE_{final}(t)=α−d/D×(α−β) Equation 2)

In Equation 2, α represents a displayed DTE DTE_{final}(tₙ) displayed on the cluster at the just previous time tₙ, d represents an actual travelling distance from the just previous time tₙ, at which the DTE a is predicted, to the specific time, and D represents an actual travelling distance predetermined for determining a time of a recalculation of the predicted DTE DTE_{predict}.

In Equation 2, β=(a−D), and is a value obtained by subtracting the predetermined actual travelling distance D from the predicted DTE (a=DTE_{predict}(tₙ)) calculated at the just previous time tₙ, and represents a displayed DTE (β=DTE_{final}(tₙ₋₁)) displayed on the cluster at a time tₙ₊₁.

Accordingly, the displayed DTE calculating unit calculates the DTE on the straight line connecting α and β for the time from tₙ to tₙ₊₁, for example, the displayed DTE indicated by DTE_{final}(t) in FIG. 4, by using Equation 2 and displays the calculated displayed DTE on the cluster, and thus the driver views the current displayed DTE DTE_{final}(t) displayed on the cluster and recognizes that the DTE is linearly decreased.

For example, as can be seen in FIG. 4, it can be seen that the current displayed DTE DTE_{final}(t) is linearly decreased from a that is the displayed DTE (DTE_{final}(tₙ) displayed on the cluster at the just previous time tₙ.

Accordingly, the driver recognizes that the DTE is gradually and linearly decreased as a traveling distance is increased, so that the driver may more easily and intuitively recognize the DTE compared to the existing case where the DTE is repeatedly increased or decreased.

Next, the displayed DTE calculation termination determining unit determines whether to terminate the displayed DTE calculation (S104).

The displayed DTE calculation termination determining unit measures the value of d, that is, the actual travelling distance travelling from the just previous time tₙ, at which the predicted DTE DTE_{predict} is calculated, to the specific time (the actual travelling distance measured by the ODO) and continuously updates the displayed DTE DTE_{final}(t) and when the displayed DTE DTE_{final}(t)≦0, the actual DTE is not left, so that displayed DTE calculation termination determining unit terminates the calculation of the displayed DTE.

In the meantime, as a result of the determination whether to recalculate the predicted DTE DTE_{predict} by the predicted DTE recalculation determining unit, when the actual travelling distance d travelling from the immediately previous time, at which the predicted DTE is calculated by using the existing DTE prediction logic, is larger than the predetermined actual travelling distance D, a step of recalculating the predicted DTE and the displayed DTE at the time of the recalculation of the predicted DTE DTE_{predict} (S105) is performed.

For example, when the actual travelling distance d travelling from the just previous time t₀, at which the predicted DTE is calculated by using the existing DTE prediction logic, is larger than the predetermined actual travelling distance D, the DTE recalculating unit recalculates the predicted DTE (a=DTE_{predict}(tₙ)) and the displayed DTE (a=DTE_{final}(tₙ)) at the time tₙ (S105), and then the method proceeds to steps S103 and S104.

Otherwise, when the actual travelling distance d travelling from the immediately previous time tₙ, at which the predicted DTE is calculated by using the existing DTE prediction logic, is larger than the predetermined actual travelling distance D, the DTE recalculating unit recalculates the predicted DTE (a=DTE_{predict}(tₙ₊₁)) and the displayed DTE (α=DTE_{final}(tₙ₊₁)) at the time tₙ₊₁ (S105), and then the method proceeds to steps S103 and S104.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A system for determining a distance to empty (DTE) of an environmentally-friendly vehicle, the system comprising:
an initial calculating unit configured to calculate a first predicted DTE (DTE_{predict}) at an initial DTE prediction time using distance to empty (DTE) prediction logic (DTE(km)=fuel efficiency [km/kWh]×available battery energy [kWh]);
a predicted DTE recalculation determining unit configured to calculate an actual travelling distance (d) travelling from a just previous time, at which the predicted DTE (DTE_{predict}) is calculated, compare the calculated actual travelling distance (d) with a predetermined actual travelling distance (D), and determine whether to recalculate the predicted DTE; and
a displayed DTE calculating unit configured to calculate a displayed DTE (DTE_{final}(t)) as a linearly decreasing value when the actual travelling distance (d) travelling from the just previous time, at which the predicted DTE (DTE_{predict}) is calculated, to a specific time is smaller than the predetermined actual travelling distance (D).

2. The system of claim 1, wherein the first predicted DTE at an initial DTE prediction time (t₀) predicted by the initial calculating unit is displayed on a cluster.

3. The system of claim 1, wherein the actual travelling distance (d) is measured by an odometer, and the predetermined actual travelling distance (D) is set for determining a time of a recalculation of the predicted DTE (DTE_{predict})

4. The system of claim 1, further comprising:
a displayed DTE calculation termination determining unit configured to determine whether the displayed DTE (DTE_{final}(t))≦0, and determine whether to terminate the displayed DTE calculation.

5. The system of claim 1, further comprising:
a DTE recalculating unit configured to recalculate the predicted DTE and the displayed DTE at a time of a recalculation of the predicted DTE (DTE_{predict}) when the actual travelling distance (d) travelling from the just previous time, at which the predicted DTE is calculated, is larger than the predetermined actual travelling distance (D).

6. A method for calculating a distance to empty (DTE) of an environmentally-friendly vehicle, the method comprising:
calculating a first predicted DTE (DTE_{predict}) at an initial DTE prediction time using distance to empty (DTE) prediction logic (DTE(km)=fuel efficiency [km/kWh]×available battery energy [kWh]);
calculating an actual travelling distance (d) travelling from a just previous time, at which the predicted DTE (DTE_{predict}) is calculated, comparing the calculated actual travelling distance (d) with a predetermined actual travelling distance (D), and determining whether to recalculate the predicted DTE; and
calculating a displayed DTE (DTE_{final}(t)) as a linearly decreasing value when the actual travelling distance (d) travelling from the just previous time, at which the predicted DTE (DTE_{predict}) is calculated, to a specific time is smaller than the predetermined actual travelling distance (D) and displaying the calculated DTE on a cluster.

7. The method of claim 6, wherein the predicted DTE (DTE_{predict}) is predicted by “DTE(km)=fuel efficiency (km/kWh)×available battery energy (kWh)” and a similar logic.

8. The method of claim 6, wherein the first predicted DTE (DTE_{predict}) is preferentially displayed in the cluster so that a driver recognizes the first predicted DTE as a current DTE.

9. The method of claim 6, wherein the actual travelling distance (d) is measured by an odometer, and the predetermined actual travelling distance (D) is set for determining a time of a recalculation of the predicted DTE (DTE_{predict})

10. The method of claim 6, further comprising:
determining whether the displayed DTE (DTE_{final}(t))≦0, and determining whether to terminate the displayed DTE calculation.

11. The method of claim 6, further comprising:
recalculating the predicted DTE and the displayed DTE at a time of a recalculation of the predicted DTE (DTE_{predict}) when the actual travelling distance (d) travelling from the just previous time, at which the predicted DTE is calculated, is larger than the predetermined actual travelling distance (D).

12. The method of claim 6, wherein the displayed DTE (DTE_{final}(t)) is calculated by an equation below,
Displayed DTE(DTE_{final}(t))=α−d/D×(α−β), Equation)
in the equation, a represents the displayed DTE (DTE_{final}(tₙ)) displayed on the cluster at the just previous time (tₙ), d represents the actual travelling distance travelling from the just previous time (tₙ), at which the DTE (a) is predicted, to the specific time, D represents an actual travelling distance predetermined for determining a time of a recalculation of the predicted DTE (DTE_{predict}), and β is a value obtained by subtracting the predetermined actual travelling distance (D) from the predicted DTE (a=DTE_{predict}(tₙ)) calculated at the just previous time (tₙ), and is a displayed DTE (β=DTE_{final}(tₙ₊₁)) displayed on the cluster at a time (tₙ₊₁).
